(19) United States
(12) Patent Application Publication
(10) Pub. No.: US 2021/0137153 A1
(43) Pub. Date: May 13, 2021

(54) Parallel-Additive Manufacturing of Objects Made of Aqueous and/or Organic Materials

(71) Applicant: The Regents of the University of California, Oakland, CA (US)

(72) Inventors: Dan Rubinsky, San Francisco, CA (US); Boris Rubinsky, El Cerrito, CA (US); Ze'ev Shaked, San Antonio, TX (US); Gideon Ukpai, Kensington, CA (US)

(73) Assignee: The Regents of the University of California, Oakland, CA (US)

(21) Appl. No.: 17/253,561

(22) PCT Filed: Jun. 28, 2019
(86) PCT No.: PCT/US2019/039895

§ 371 Date: Dec. 17, 2020

Related U.S. Application Data
(60) Provisional application No. 62/694,753, filed on Jul. 6, 2018.

(51) Int. Cl. A23P 20/20; A23L 33/00; B33Y 10/00; B33Y 40/10; B33Y 30/00; B33Y 70/00

(52) U.S. Cl. CPC A23P 20/20; A23L 33/40; B33Y 10/00; A23P 2020/253; B33Y 30/00; B33Y 70/00; B33Y 40/10

(57) ABSTRACT

A method of additive manufacturing biological matter is provided. The method includes preparing an aqueous solution, combining the aqueous solution with a thickening gent, forming the combination into a plurality of two-dimensional individual volume elements in parallel, assembling the plurality of individual volume elements in a three-dimensional array and solidifying the three-dimensional array. Methods of additive manufacturing a food product and a three-dimensional structure with aqueous solution or organic matter are also provided. A system for additively depositing elements including an aqueous solution or organic matter is also provided.

### FIELD OF THE TECHNOLOGY

Aspects relate generally to systems and methods for additive manufacturing of three dimensional (3D) objects from aqueous solutions and organic materials, and, more specifically, to additive manufacturing of such 3D objects in parallel.

### BACKGROUND

Three-dimensional objects can be made by joining or solidifying fluid material in a three-dimensional configuration under a process called additive manufacturing. The process usually involves computer control to create the three-dimensional shape. Additive manufacturing has been used to create products in numerous industries including aerospace, architecture, automotive, defense, prosthetics, and others. Each industry utilizing additive manufacturing methods may have different requirements for the type and quality of products manufactured.

Biological material products are typically difficult and time consuming to produce. For example, synthetic biological materials must be made to function like natural tissues. Natural food products and synthetic food products must be safe for consumption and able to provide the necessary nutrients to the consumer. Currently, there is a need for efficient and highly specialized production of biological material.

### SUMMARY

In one aspect, there is provided a method of additive manufacturing biological matter. The method may comprise preparing an aqueous solution comprising organic matter, combining the aqueous solution with a thickening agent to produce a deposition mixture, forming the deposition mixture into a plurality of two-dimensional individual volume elements in parallel, each individual volume element formed on a first surface, transferring the plurality of individual volume elements to a second surface, assembling the plurality of individual volume elements on the second surface in a three-dimensional array, and solidifying the plurality of individual volume elements in the three-dimensional array, thereby additive manufacturing the biological matter.

In accordance with certain embodiments, forming the deposition mixture into a plurality of two-dimensional individual volume elements may comprise increasing mechanical rigidity of the deposition mixture to form the plurality of two-dimensional individual volume elements. Forming each individual volume element on a first surface may comprise binding each individual volume element to the first surface to provide the mechanical rigidity to the plurality of two-dimensional individual volume elements. The method may further comprise releasing the plurality of individual volume elements from the first surface. The method may further comprise binding each individual volume element to the first surface against the force of gravity.

In some embodiments, additive manufacturing the biological matter comprises additive manufacturing an organ, a tissue, or tissue scaffold. The method may further comprise implanting the organ, tissue, or tissue scaffold in a subject in need thereof.

The method may further comprise evaluating the organ, tissue, or tissue scaffold in vitro.

The method may further comprise evaluating the organ, tissue, or tissue scaffold in vivo.

In accordance with some embodiments, the thickening agent may comprise at least one of agar, collagen, and an alginate.

In some embodiments, the thickening agent may comprise agar and the method may comprise combining the aqueous solution with the agar at a temperature of greater than about 80° C. The method may further comprise assembling the three-dimensional array at a temperature of between about 20° C. and about 40° C.

In some embodiments, the thickening agent may comprise collagen and the method may comprise combining the aqueous solution with the collagen at a temperature of between about 0° C. and about 5° C. Solidifying the plurality of individual volume elements in the three-dimensional array may comprise increasing the temperature of the assembled plurality of individual volume elements to a temperature of between about 20° C. and about 40° C.

In some embodiments, the thickening agent may comprise an alginate. The thickening agent may comprise sodium alginate and solidifying the plurality of individual volume elements in the three-dimensional array may comprise combining the deposition mixture with calcium carbonate and D-Gluconic acid δ-lactone.

In some embodiments, the method may further comprise cross-linking the plurality of individual volume elements in the three-dimensional array.

In accordance with another aspect, there is provided a method of additive manufacturing a food product. The method may comprise preparing an aqueous solution comprising a food base, combining the aqueous solution with an edible thickening agent to produce a deposition mixture, forming the deposition mixture into a plurality of two-dimensional individual volume elements in parallel, each individual volume element formed on a first surface, transferring the plurality of individual volume elements to a second surface, assembling the plurality of individual volume elements on the second surface in a three-dimensional array, and cross-linking the plurality of individual volume elements in the three-dimensional array, thereby additive manufacturing the food product.

In some embodiments, the method may comprise selecting the viscosity and texture of the food product to be suitable for a subject in need thereof. For instance, the method may comprise selecting the viscosity and texture of the food product to be suitable for a subject with esophageal dysphagia.

The food base may comprise at least one of a protein, a fat, and a carbohydrate.

The food base may comprise cells grown in an in vitro cell culture.

In accordance with certain embodiments, the edible thickening agent may comprise sodium alginate. Cross-linking the plurality of individual volume elements may comprise combining the plurality of individual volume elements with calcium chloride.

Cross-linking the plurality of individual volume elements may comprise freezing or heat-treating the plurality of individual volume elements.

In some embodiments cross linking is done before freezing and in other embodiments cross linking is done after freezing.

The method may comprise structurally reinforcing the plurality of individual volume elements before transferring the plurality of individual volume elements to the second surface. Structurally reinforcing the plurality of individual volume elements may comprise freezing the plurality of individual volume elements.

In accordance with another aspect, there is provided a method of additive manufacturing a three-dimensional structure comprising an aqueous solution or organic matter. The method may comprise preparing a first solution comprising the aqueous solution or organic matter, forming the first solution into a plurality of two-dimensional individual volume elements in parallel, each individual volume element formed on a first surface, transferring the plurality of individual volume elements to a second surface, assembling the plurality of individual volume elements on the second surface in a three-dimensional array, and freezing the plurality of individual volume elements in the three-dimensional array, thereby additive manufacturing the biological matter.

The method of additive manufacturing a three-dimensional structure comprising an aqueous solution or organic matter may further comprise freezing the plurality of individual volume elements on the first surface.

In accordance with yet another aspect, there is provided a system for additively depositing elements comprising an aqueous solution or organic matter. The system may comprise one or more print stations operating in a parallel configuration, a build station configured to arrange an individual volume element in a three-dimensional structure, and a transport subsystem configured to transport the individual volume element. The one or more print stations may each comprise an individual volume element print head positioned to deposit the individual volume element on a first surface. The one or more print stations may comprise a print station temperature control device. The build station may be configured to arrange the individual volume element in a three-dimensional structure on a second surface. The build station may comprise a build station temperature control device. The transport subsystem may be configured to transport the individual volume element between the first surface and the second surface. The transport system may comprise a transport temperature control device. Any one or more of the temperature control devices may be electrically connected to a control module configured to regulate temperature.

In some embodiments, the first surface may comprise a hydrophilic portion. In some embodiments, the first surface may comprise a hydrophobic portion. The hydrophilic portion may be arranged in a desired design for a two-dimensional individual volume element.

The print station temperature control device may be configured to maintain a liquid temperature of the individual volume element.

The build station temperature control device may be configured to maintain a solid temperature of the three-dimensional structure.

The transport subsystem temperature control device may be configured to maintain a solid temperature of the individual volume element.

In some embodiments, the transport subsystem may further comprise a binding mechanism configured to bind the individual volume element to the first surface during transport. The transport subsystem may further comprise a removal mechanism configured to remove the individual volume element from the first surface for assembly.

In some embodiments, the individual volume element print head is positioned, e.g., capable or constructed and arranged, to deposit the individual volume element on the first surface against the force of gravity.

The disclosure contemplates all combinations of any one or more of the foregoing aspects and/or embodiments, as well as combinations with any one or more of the embodiments set forth in the detailed description and any examples.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic diagram of two exemplary methods for 3D printing an individual volume element on a printing surface;

FIGS. 2A-2C include an image of an ice crystal dendritic structure (FIG. 2A), a schematic drawing of an ice crystal dendritic structure with liquid and solid between the crystals (FIG. 2B), and an electron micrograph image of a freeze-dried structure (FIG. 2C);

FIGS. 3A-3E include a schematic drawing of individual volume elements and a 3D printed structure including the same and a schematic drawing of individual 2D layers and a 3D assembly of the same;

FIGS. 4A-4B are schematic drawings showing steps of an exemplary method of producing a 3D printed object, according to certain embodiments disclosed herein;

FIG. 5 is a schematic drawing of an exemplary surface containing hydrophobic portions and hydrophilic portions, according to certain embodiments disclosed herein;

FIGS. 6A-6C include images of various tools to produce 2D layers, according to certain embodiments disclosed herein;

FIG. 7 is a schematic diagram of a 3D printing system in the process of producing a 3D object, according to one embodiment disclosed herein; and

FIG. 8 is a side view of a 3D printed object showing the various layers of the object, according to certain embodiments disclosed herein.

### DETAILED DESCRIPTION

Systems and methods are presented through which additive manufacturing of three dimensional (3D) objects made of aqueous and/or organic materials is performed. In some embodiments, the manufacturing is performed in at least two separate stations, wherein at one station a part of the 3D object is manufactured and at another station the parts manufactured separately are assembled in a 3D structure. In contrast, conventional additive manufacturing of one 3D object of aqueous solutions and organic materials is generally performed at one single station.

Methods and systems are introduced herein through which the parts of the 3D object manufactured separately, which being made of aqueous solutions and organic materials have little mechanical rigidity, can be transported from one station to the other and integrated in the manufactured 3D object. Without wishing to be bound by theory, it is believed that in some embodiments the systems and methods described herein can provide mechanical rigidity to aqueous and/or organic materials by binding to a transfer surface, for example, by selectively and/or removably binding to a transfer surface. In some embodiments, the systems and methods described herein can provide mechanical rigidity to aqueous solutions and/or organic materials by cooling or freezing. Furthermore, without wishing to be bound by theory, it is believed that in some embodiments the systems and methods described herein can facilitate assembly of the 3D object from multiple components and/or binding of the multiple components into a 3D structure, for example, by solidifying the 3D structure with forces stronger than those binding the individual components to the transfer surface. The cross linking of certain products can be done before freezing and in others after freezing. It is believed such systems and methods may maintain viability of the biological materials produced thereby or avoid the spoilage of food materials during the printing.

Additionally, systems and methods may further perform the manufacture of 3D objects of aqueous solutions and organic materials in a parallel form, such that all the steps of the additive manufacturing are not performed sequentially at one station (as in conventional additive manufacturing) but rather in at least two stations where the steps can be performed in parallel. These systems and methods can facilitate large scale additive manufacturing of 3D objects made of aqueous solutions and/or organic materials by operating in parallel, thereby reducing the time of the manufacturing of the 3D object.

### Additive Manufacturing

Additive manufacturing (AM) is of increasing importance in almost every field of technology. Conventional additive manufacturing and 3D printing is typically characterized by a linear process in which each individual volume element is incorporated in the 3D structure in a linear manner, element by element. Additive manufacturing technologies have been developed as an alternative to conventional milling techniques to produce complex three-dimensional (3D) objects. Unlike milling that removes material from a volume of matter to produce a 3D object, additive manufacturing builds a solid 3D structure by assembling individual volume elements (IVE) to form the 3D object.

The basic concept in additive manufacturing is the assembly of a 3D structure from individual volume elements (IVE), IVE by IVE. The IVE is the basic building block of the process. Typically, IVE's are first incorporated element by element in one layer and then the assembling proceeds, also element by element to a second layer on top of the first layer, and continues to produce subsequent layers, IVE by IVE. In conventional additive manufacturing, the assembly of each element that forms the 3D structure is performed using computer control over the deposition of individual volume elements (IVE). The entire assembly process of IVE by IVE in layers by layer is conventionally performed in one device.

There are a variety of technologies that may qualify as additive manufacturing. These technologies have in common the incorporation of simple small elements (IVE) by small elements (IVE) to form a large and complex 3D structure. For example, laser or electron beam, UV light cure, or sinter material (powder) can be performed by adding IVE by IVE to form a layer followed by another layer made of IVE. Often, the process is performed in the same device and in a linear manner, in regard to the deposition and the incorporation of the IVE. Another additive manufacturing technique ejects a liquid material from a nozzle head, and forms a 3D structure IVE by IVE and layer by layer in the same device. This approach is generally known as 3D printing.

A key aspect of additive manufacturing is the technology for merging each individual volume element into the 3D structure. In additive manufacturing, the complex 3D object may be generated from a 3D computer aided design (CAD) model, optionally as a complete object. The object may be created by assembling the IVE in a layer in such a way that each IVE is merged to the adjacent IVE until the layer is complete. A subsequent new layer may be formed over the previous layer, optionally in the same apparatus. Manufacturing may proceed layer upon layer in such a way that the layers merge with each other creating a complete 3D object. Regardless of the additive manufacturing method employed, an important key element in additive manufacturing and 3D printing is the merging of each IVE into the 3D object.

3D printing is one of the more widely used additive manufacturing techniques. In 3D printing, IVE are laid down via computer control to generate a 3D structure by binding element by element to the previously incorporated element. These objects can have any shape, geometry, and composition. The objects may be produced from 3D models or another electronic data source. There are a variety of manufacturing methods that can be classified as 3D printing. There is a common technological feature to all these methods. The material used in each IVE generally undergoes a transformation in material properties from a malleable state of matter when added to the printed object to a solid state of matter when incorporated in the 3D printed object. This transformation is responsible for incorporating the new element to previously deposited elements, eventually forming the desired manufactured object. As mentioned earlier the merging of each IVE into the 3D structure is central to the success of additive manufacturing.

For example, many of the currently used 3D printing technologies employ for printing various plastic materials in which the phase transition temperature of the printed material is higher than the room temperature. Therefore, when deposited in a warm liquid state, each IVE can solidify at room temperature. Printing in air at room temperature is common to majority of 3D printing techniques. For example, fused filament fabrication (FFF) is one of the most popular technologies in which a plastic filament from a coil can be driven to the extrusion nozzle and then passed through the heater with the required melting temperature. The object can be printed IVE by IVE on one layer and layer by layer with the same technique using IVE deposition. After flowing through the extrusion nozzle the material generally solidifies upon deposition onto the 3D printed object. The application of pressure in the nozzle typically pushes the semisolid material out of the nozzle. The stable pressure and constant moving speed of the nozzle can result in a uniform extrusion and, therefore, in a more accurate product. This method can allow achieving precision in depositing each element that forms the printed object.

One 3D printing technology employs a printer head that delivers the material to be printed (e.g., plastic) in a molten form at a controlled rate and temperature. The plastic material is typically heated and softened in the printer head. The head can have the ability to move in an X-Y plane and the printing table can move on a Z-axis under computer control, enabling the manufacturing of complex shapes. The molten material is typically deposited drop by drop on the printing table where it can solidify. The process generally continues until a layer is completed. Then the printing table can move downwards, and another layer is deposited IVE by IVE.

The force of gravity may be employed in 3D additive manufacturing. There are several uses to the force of gravity. The force of gravity may be used as an aid to hold the 3D printed object in place on the printing table, for example, as IVE by IVE are deposited. The force of gravity may also be used to maintain the IVE in place as it is deposited. The force of gravity may also be used to direct the IVE to the proper deposition site. For example, in 3D printing of a molten plastic material the process may be carried out in open air and room temperature. Typically, the phase transition temperature of the molten plastic is higher than room temperature. The 3D printed object may rest on a printing surface, and the liquid IVE may be held in place upon deposition, first by the force of gravity. To the best of our knowledge there is no 3D printing technique from liquid in which the IVE experiences the force of gravity in a direction opposite to the direction of the IVE deposition. FIG. 1 illustrates this point. It will be shown later, that the force of gravity may also be employed in additive manufacturing of objects made of aqueous and/or organic materials.

Materials and Uses of Additive Manufacturing of 3D Objects Made from Aqueous and/or Organic Substances

Additive manufacturing of 3D objects of biological matter may generally involve aqueous solutions and organic molecules. There are several applications for 3D additive manufactured biological matter, including, for example, tissue engineering, food engineering, and manufacturing of biological scaffolds and freeze-dried scaffolds. Materials which may be employed in tissue engineering include, for example, hydrogels, collagen, alginates, and mixtures thereof, optionally incorporating hydrogels. Food items may include, for example, mixtures and processed mixtures of cells from animal or vegetative sources, combinations thereof, and combinations of these products with hydrogels, alginates and collagens.

The main goal of tissue engineering is typically to develop engineered biological substitutes to replace failing human organs and tissues, restore functioning organs, or replace animal organs and tissue in research contexts. An important aspect of tissue engineering is the manufacturing of a tissue scaffold, which forms the extracellular matrix on which cells grow. Additive manufacturing methods, such as 3D printing, are of increasing interest in tissue engineering in general, and in scaffold fabrication in particular. In tissue engineering of scaffolds, the printing medium may be a hydrogel. In tissue engineering of scaffolds, the printing medium may be a hydrogel, collagen, alginate, and mixtures thereof.

Additive manufacturing and 3D printing may also be employed in food manufacturing. In the health-related food industry, additive manufacturing may be employed for producing food catered toward consumers with specific diseases and/or nutritional needs. For example, food products may be produced by additive manufacturing for patients with dysphagia, for example, elderly patients with dysphagia. Dysphagia is an impairment of the ability to eat, drink or swallow. With the increasing aging population, dysphagia and its related eating impairments are becoming an acute medical problem. Additive manufacturing of food products can be used to produce foods that will benefit patients with dysphagia, for example, by generating more aesthetically and texturally pleasing products. 3D printing may also be used to produce foods with a 3D structure that is esthetically pleasing, for example, chocolate, or special combinations of ingredients, for example, including chocolate.

Additive manufacturing may be employed to produce artificially grown meat. In many circumstances, artificially grown meat is produced in the form of cellular mixtures, lacking form and shape. 3D additive manufacturing can be employed to generate more aesthetically and texturally pleasing food items from artificially grown meat, for example, food products that resemble natural meat products in form and texture. Natural meat products which the 3D objects may resemble include food products produced from meat, poultry, or fish, for example, chicken, turkey, beef, lamb, veal, pork, venison, fish, or shellfish. Each of these food products may have a specific form and texture which can be mimicked by the artificial 3D-produced food product, as disclosed herein.

Merging an IVE of Aqueous Solutions and/or Organic Materials into a 3D Object

As with other 3D additive manufacturing methods, the merging of an IVE into a 3D structure can also be of importance in manufacturing a 3D object made of aqueous solutions and organic matter. Several methods may be employed to merge each IVE made of aqueous solutions and organic matter in the 3D structure. For example, for a gel-based product, e.g., agar gel or hydrogel, the IVE may be delivered in liquid form, e.g., warm liquid, and solidify into the 3D structure by gelling, e.g., by cooling. In another example, alginate-based IVE may be deposited in a liquid form and then incorporated into a 3D shape by cross-linking each element with a crosslinker, e.g., calcium dichloride (CaCl₂) or calcium carbonate (CaCO₃). In yet another example, collagen may be deposited as a liquid at lower temperatures which gels at elevated temperatures. A collagen-based IVE may be cooled to remain fluid for deposition. Each deposited element may be warmed upon deposition to form a gel and a 3D structure made from deposition of IVE by IVE. Food products or cells can be also mixed with agar or alginate or collagen and used to form 3D structures in a similar way. Other food products that are liquid and solidify upon change in temperature, such as chocolate or ice cream, may also be used in 3D printing in a similar form, e.g., IVE by IVE. The above are examples from a large variety of methods which may be employed in additive manufacturing to add and merge IVE in a 3D structure.

For example, one 3D printing method for tissue engineering employs drops as the IVE. Drop-based printing creates cellular constructs using individual droplets of a designated material, usually agarose, which has oftentimes been combined with a cell line. Upon contact with the substrate surface, each agarose IVE begins to polymerize, forming a larger structure as individual droplets begin to coalesce. Polymerization is instigated by the presence of calcium ions on the substrate, which diffuse into the liquefied IVE and allow for the formation of a solid gel. Drop-based printing is commonly used due to its efficient speed, though this aspect makes it less suitable for more complicated structures.

Another method for delivering the printed material in tissue engineering is by extrusion through the orifice of a nozzle. Extrusion bioprinting may be performed by a constant deposition of a particular printing material and cell line from an extruder, a type of mobile print head. Extrusion printing can be a more controlled and milder process for material or cell deposition. Extrusion printing may allow for greater cell densities to be used in the construction of 3D tissue or organ structures. However, such benefits are set back by the slower printing speeds obtained by this technique. Extrusion bioprinting may also be coupled with UV light to photo polymerize the printed material, forming a more stable, integrated construct. Extrusion printing may generally be used with 3D printing for tissue engineering, where the printed material is fluid and solidifies upon deposition.

Another method that may be employed to merge an IVE of an aqueous solution and/or organic material into a 3D object is freezing. The IVE may comprise a liquid aqueous solution, for example, consist essentially of an aqueous liquid solution or consist of an aqueous liquid solution. The aqueous liquid solution-based IVE may be deposited on a subfreezing temperature cold surface or on a subfreezing temperature layer of frozen material. The aqueous liquid solution-based IVE may then freeze. The freezing may bind the IVE to the surface on which it is deposited. This use of freezing to bind aqueous IVE's for 3D additive manufacturing may be utilized in tissue engineering, in particular, to produce tissue scaffolds from freeze-drying and in food to prepare foods with desired microstructure. The cross linking of certain products can be done before freezing and in others after freezing. For cross linking after freezing, the frozen object can be immersed in a solution containing the cross linker at a temperature higher than the freezing temperature and the cross linker penetrates the object by diffusion as the frozen object thaws.

3D Object Design with Additive Manufacturing

A major attribute of value in 3D printing is the control over the macrostructure of the object. In some embodiments, control may be achieved through IVE by IVE deposition and incorporation of the additive elements (IVE) at precise locations. In additive manufacturing by freezing, it is also possible to control the microstructure of the 3D object. One method of controlling the microstructure in a 3D object by using freezing in additive manufacturing is described in International Patent Application Publication No. WO2017/066727 titled “Systems, Apparatus and Method for Cryogenic 3D Printing,” which is incorporated herein by reference in its entirety for all purposes.

Briefly, ice crystal size and orientation are major factors that may affect the microstructure of the 3D object. The ice crystal size and orientation may generally depend on the thermal history during freezing. By controlling the thermal history it is possible to control the microstructure. Some applications in which control over the microstructure is valuable include, for example, 3D printing of food (e.g., ice cream, beer, beverages, with and without gas, hamburgers, cakes, artificial protein products, e.g., meat and cheese products) where small ice crystals tend to improve the quality of the product and retain the original composition; 3D printing of frozen structures may also be a first step in a freeze-drying process, where the size of the ice crystals tends to determine the empty volume dimensions after the freeze-drying; 3D printing of biological organs and tissues in a frozen state, where the cooling rate may have an effect on printed cell survival as well as structure of the scaffold; and 3D printing of frozen foods, where the quality of the food may depend on generating small ice crystals. In general, any additive method involving solidification of the printed material by freezing may benefit from the microstructure being controlled through control of the temperature history during freezing.

The porosity of the 3D object is another design parameter that may be controlled. Generally, porosity of tissue scaffolds may be a key parameter in scaffold design. One method for producing pores is by freezing and then freeze-drying a gel, e.g., hydrogel solution. For example, a method for manufacturing porous scaffolds for tissue engineering using alginate-based IVEs can comprise: preparing a solution of sodium alginate and casting the solution in a desired form; crosslinking the alginate solution with calcium ions; freezing the crosslinked alginate solution; and removing ice crystals by sublimation (freeze-drying).

Briefly, because ice has a tight crystallographic structure, when an ice solution freezes the solutes are typically rejected by the ice front while the ice crystals are made of pure water. Constitutional supercooling may cause the ice front to become dendritic (fingerlike) in the direction of propagation, potentially entrapping solutes between the ice crystals. After freeze-drying, the ice crystal sites form the pores and the solutes between the ice crystals may form the walls of the pore. FIG. 2 shows images of dendritic (finger like) ice crystals and the structure that remains after freeze-drying. The dimensions of the dendrites may be related, e.g. directly related, to the rate of freezing and the amount of solutes in the solution, wherein higher cooling rates tend to produce smaller ice crystals.

Furthermore, the freezing process may involve the attachment of water molecules to an existing ice crystal. In water, the attachment typically occurs along the ice crystal planes. The microscopic mode of freezing may be determined by the original configuration of the first ice crystal and the temperature gradient in the freezing milieu. The mode of freezing and the directionality of the freezing process may affect the ultimate size and form of the pores created by the removal of the ice through freeze-drying. Directional solidification may be employed as a method to produce a tissue scaffold in which the dimensions and the direction of the pores are controlled by controlling the direction in which the ice crystals propagate and the thermal history during freezing. An exemplary device and method in which ice crystal size and orientation are controlled throughout the 3D object made by additive manufacturing are described in International Application Publication No. WO2017/066727.

The use of freezing to produce a porous scaffold through subsequent freeze-drying may also be employed in 3D printing. In such a method, unfrozen, liquid voxels are added to the assembled frozen structure, frozen in situ, and adhered to the rest of the structure, thereby forming the 3D object. When an aqueous solution is deposited on a frozen layer, the ice crystals that form in the deposited aqueous solution tend to follow and be incorporated in the existing ice crystals, thereby binding the deposited volume of liquid to the previously frozen layer. This is a way of attachment of individual deposited volume elements to an already frozen structure, during 3D printing of a frozen aqueous solution. Subsequent freeze-drying may produce the tissue scaffold.

As described above, the eventual size, direction, and shape of the pores will generally depend on the thermal parameters during freezing. Several additive manufacturing methods may be used to produce 3D printed frozen structures. In one method, known as low-temperature deposition (LTD), the entire printing table and printed volume may be positioned in an air-filled refrigerated chamber. Heat may be extracted from the freezing object through the freezing stage, by conduction, and by natural convection in the surrounding air. Another method employs a low-temperature stage in air in which the heat transfer may be performed primarily by conduction through the frozen layer(s) and into the freezing surface. As a variant of this method, the printing stage and the air surrounding it may be maintained at a low temperature. In all of the above methods, it may be difficult and sometimes impossible to precisely control the size and orientation of the ice crystals.

An exemplary technology that can overcome the drawbacks of the 3D printing with freezing methods described above is presented in International Patent Application Publication No. WO2017/066727. Briefly, a 3D cryoprinting method is provided in which the printed object may be immersed in a subfreezing temperature fluid that remains at a predetermined distance from the last printed layer, throughout the entire printing process. In the system described in WO2017/066727 the thermal gradient on the last frozen layer and in each deposited new element can be precisely controlled, resulting in a directionally controlled microstructure. The goal of the system is to 3D cryoprint a tissue that incorporates living cells and to develop a technique for printing large biological objects.

Conventional 3D printing is generally slow, which may cause spoiling of biological matter and cell death during the printing process. However, cells can survive freezing and their survival is often dependent on the thermal history during the freezing process. The controlled freezing of each deposited volume can result in a frozen cell that will survive freezing, within a large frozen object. Other applications of this method include, for example, producing freeze-dried scaffolds and frozen food products with controlled microstructure.

In addition, freezing is a well-established method of food preservation. Higher cooling rates, with their accompanying small ice crystals, tend to result in a higher quality frozen food product. The freezing method can also control the freezing of each particle of food with high and controlled cooling rates, thereby producing smaller ice crystals. Therefore, this technique is also of practical use in 3D cryoprinting of frozen food.

### Mass Manufacturing of Additive Manufacturing Products

One drawback of conventional additive manufacturing is the linear production method, which is not amenable to mass manufacturing. A conventional technological element of the 3D printing manufacturing process is the use of a printer head (or the orifice of a nozzle) that distributes single volumes (IVE) in the process described above, e.g., element by element and layer by layer. From the earlier description it is evident that the process of single volume deposition (IVE) is a linear process in which each addition of a single volume (IVE) follows the other in time, to produce a single layer and each layer follows the other. This method makes the manufacturing of the printed object a lengthy linear process because each volume element deposition must follow the previous. For an additive manufacturing process to be economical in high volume manufacturing it must be scalable, fast, and efficient to compete with more mature manufacturing technologies.

Current 3D printing technologies fall short in these areas because tracing out each element of a 3D object is an inherently slow process and there are no efficiency gains when manufacturing in higher volumes. Conventional 3D printing is a serial process for which the build time cannot be shortened by making more simultaneously. Long manufacturing times with each printed object occupying one printing machine makes the entire 3D printing process time consuming and expensive. Attempts have been made to speed up the process by using several single volume heads in parallel. While this method may speed up the process, the single volume deposition generally remains a linear process that occurs entirely in one machine. For example, if the production of one object in a 3D printer takes ten hours, to increase productivity and produce ten objects, ten (expensive) 3D printing devices would be needed under conventional methods. Alternatively, if only one 3D printing device is available the production would conventionally take 100 hours.

The lengthy production process of linear additive manufacturing can be particularly detrimental to production of biological matter, which may not survive long periods of time outside an environment designed for the survival of such matter. Cells may not survive long periods of time outside a temperature-controlled cell culture environment. Meat products may become contaminated by microorganisms during a lengthy additive manufacturing process outside refrigeration.

Additionally, the linear additive manufacturing process may not be conducive to mass fabrication. Generally, there are no efficiency gains when manufacturing linear products in higher volumes. For example, printing a two-inch height object by linear manufacturing may take between 10 minutes and several hours, depending on the size, shape, and print settings. Successful high-volume manufacturing technologies may greatly benefit from the efficiency gains obtainable by parallel processing when scaling up from production of one object to higher quantities. As disclosed herein, the parallel additive manufacturing systems and methods may be scalable, fast, and efficient. Efficient mass manufacturing may leverage parallel processing to reduce individual build times. Thus, the systems and methods disclosed herein can be used to substantially increase the productivity of additive manufacturing.

Parallel additive manufacturing methods disclosed herein may employ multilayer lithography methods to enable efficient scaling of production. Multilayer lithography may increase the efficiency of bioprinting by enabling parallel production of multiple individual layers of the 3D structure. In some embodiments, a multilayer or print lithography approach is employed for parallelizing the additive manufacturing process. Parallel manufacturing is commonly used in assembly of parts, such as in the automobile industry. Because current 3D printing technology is employed as a serial process it is not easy to scale up to mass manufacture of consumer goods in an economically feasible manner. Introducing parallel methods in additive manufacturing techniques would facilitate scaling up to mass manufacturing. These methods are particularly relevant in the use of additive manufacturing for tissue engineering or food, where the materials used for manufacturing the object can deteriorate during the manufacturing process.

Print lithography methods can be used, with some modifications, for 3D additive manufacturing. In modern lithography, the image is generally made of a polymer coating applied to a flexible plastic or metal plate. The image can be printed directly from the plate (the orientation of the image is reversed), or it can be offset by transferring the image onto a flexible sheet (rubber) for printing and publication. Multilayer print lithography can employ this method to deposit layer upon layer of print and thereby form a multilayer print. Another method of print lithography employs rollers that continuously deposit the image on a sheet of paper that passes underneath the rollers. Any of these print lithography methods may be adapted for 3D additive manufacturing, according to certain embodiments disclosed herein.

The application of print lithography methods to make a 3D object by additive manufacturing can be imagined in a similar manner to printing a book. In this exemplary comparison, each page is a slice of the book stacked one on top of another to form the book as a whole. To make the book with a printing press there would be a lithographic plate corresponding to each page enabling quick and easy replication. Two or more pages could be printed at once and later assembled into the final book, exemplifying the parallel process lithography methods disclosed herein. Much in the same way as a page is a slice of a book, a “layer” can be a slice of a 3D printed object. The lithographic bioprinting technology can be employed to make each slice of the 3D printed object in parallel and assemble them into a final product in a fraction of the time current linear 3D printing technology would take.

There is, however, a major difference between the assembly of a book and the assembly of a 3D object made by additive manufacturing. In a book, the pages of the book provide a physical medium with mechanical rigidity for carrying the print. In the additive 3D manufacturing technology introduced here, an object can be produced with a method resembling print lithography, however, in which only the “printed letters” are assembled one on top of the other without the use of physical carrier medium, e.g., a page made of paper.

An important aspect of 3D printing or print cryo lithography is the cross linking of the printed object. The cross linking of certain products can be done before freezing and in others after freezing. For cross linking after freezing, the frozen object can be immersed in a solution containing the cross linker at a temperature higher than the freezing temperature and the cross linker penetrates the object by diffusion as the frozen object thaws.

### Multilayer Print Lithography for use in Additive Manufacturing of 3D Objects Made of Aqueous Solutions and Organic Matter

Disclosed herein are:

a) systems and methods that facilitate the transport of a part made of aqueous solutions and/or organic matter lacking mechanical rigidity from one station to the other; and

b) systems and methods that facilitate the incorporation of a part made of aqueous solutions and/or organic matter lacking mechanical rigidity in a 3D object when transported from one manufacturing station to another.

Systems and methods are described herein that facilitate a more rapid additive manufacturing process of the 3D object made of aqueous solutions and/or organic materials with valuable applications to large scale production of multiple products. Briefly, a 3D object may be generated by assembly of two dimensional (2D) layers, where the 2D layers may be manufactured separately and in parallel and assembled into a 3D object. This invention is generally designed for materials that are made of aqueous solutions and/or organic matter. This disclosure describes various embodiments of additive manufacturing with aqueous solutions and/or organic matter, however, this disclosure is not limited to aqueous solutions and organic matter and the aspects and embodiments disclosed herein are applicable to additive manufacturing used of any one of multiple types of matter and for any one of multiple purposes. All materials used in tissue engineering or food manufacturing as described above can be used in this invention. The merger of each IVE in the 2D layer and between 2D layers can be performed by any one or more of the methods used for merging an IVE in a 3D structure in additive manufacturing, as previously described above. Furthermore, the systems and methods disclosed herein can employ any of the methods described above to incorporate each element in a complete structure.

An important aspect of 3D cryo printing or print cryo lithography is the cross linking of the printed object. The cross linking of certain products can be done before freezing and in others after freezing. For cross linking after freezing, the frozen object can be immersed in a solution containing the cross linker at a temperature higher than the freezing temperature and the cross linker penetrates the object by diffusion as the frozen object thaws.

Exemplary methods that can be employed for merging elements in a 2D structure, multiple 2D elements to each other to form a 2D or 3D structure, and multiple 3D structures include, for example, chemical polymerization of the deposited volume, polymerization (crosslinking), laser polymerization, UV curing, and thermal curing, e.g., gelling of collagen trough temperature elevation, gelling of agar through temperature depression, and freezing. In accordance with certain embodiments, 2D layers produced by the systems and methods discussed herein can be merged by freezing. These systems and methods can be employed for manufacturing of large organs for tissue engineering, scaffolds, and large structures of food. Furthermore, these systems and methods can be employed for more rapid and large-scale manufacturing of such biological objects.

As disclosed herein, parallel additive manufacturing comprises assembling separately a more complex substructure of several elements, for example, a layer or part of a layer, and then manufacturing the 3D structure from the assembly of substructures. The advantage of parallel additive manufacturing over conventional linear additive manufacturing is that each substructure can be manufactured separately and in parallel, thereby substantially reducing the time required for the manufacturing of the 3D structure. In certain embodiments, the method of parallel additive manufacturing includes transport of the substructure and assembly of the substructures.

In general, 3D printing additive manufacturing methods draw from the technology of 2D single printing layer methods and expand on that technology by 2D printing layer upon layer, to generate the 3D object. Similarly, the parallel additive manufacturing technology disclosed herein may incorporate principles of print lithography, which deal primarily with the deposition of hydrophobic inks and in which the final print can be produced via the assembly of multiple intricate layers prepared separately. The methods of parallel additive manufacturing disclosed herein may further incorporate print lithography methods to generate 3D objects for particular applications related to aqueous solutions and organic molecules.

Also disclosed herein is a device and method that can achieve control over the local macrostructure of the assembled object and control over the local microstructure of the assembled object. Macroscopic resolution can be achieved by parallel additive manufacturing, for example, by using an IVE for producing a 2D layer. The method and device may be employed to control the thermal composition and geometrical parameters of the solidification process of each assembled element as it is additively deposited.

In general, cross linking is required to provide rigidity to the object. Regardless of the method of cross linking in parallel manufacturing the cross linking can be done before the assembly of the object or after the assembly of the object. In contrast, in conventional 3D printing the cross linking must be made the latest during the assembly, because the assembly is element by element rather than complete layer by complete layer.

### Description of the Figures

FIG. 1 shows an exemplary 3D printing procedure in which the IVE is deposited on the printing surface in the direction of gravity in comparison with a hypothetical 3D printing procedure in which the IVE is deposited on the printing surface against the force of gravity. To the best of the inventors' knowledge, 3D printing is typically not conventionally performed as described in the hypothetical 3D printing procedure.

FIGS. 2A-2C show certain aspects of formation of tissue scaffolds, including (FIG. 2A) ice crystal dendrites with finger like shapes; (FIG. 2B) a schematic drawing of an ice crystal dendritic structure and the liquid and solid between the ice crystals; and (FIG. 2C) an electron micrograph of a freeze-dried structure formed by freeze-drying of alginate made by directional solidification.

FIGS. 3A-3E include schematic drawings of an exemplary linear 3D printing system in comparison with an exemplary parallel 3D additive manufacturing system. FIG. 3A shows an exemplary individual volume element. FIG. 3B shows an exemplary process by which multiple individual volume elements can be combined, for example, one by one, to produce a complex 3D structure. FIG. 3C shows a complex 2D structure that can be made with 2D printing of elements, such as those shown in FIG. 1A. FIG. 3D shows an exemplary process by which numerous 2D structures, such as those shown in FIG. 2D and variations thereof, can be manufactured in parallel. FIG. 3E shows an exemplary process by which the various 2D structures shown in FIG. 3D can be assembled into a 3D structure.

FIGS. 4A-4D show an exemplary method for producing a 3D object with parallel additive manufacturing. As shown in FIGS. 4A and 4B, a 2D layer may be formed on a hydrophilic surface. The hydrophilic forces binding the aqueous solutions to the surface may facilitate turning over to a transfer surface while the hydrophilic forces may generally be employed to overcome the pull of gravity. This method allows the deposition of the 2D layer for assembly in the 3D structure, as shown in FIG. 4C. In this exemplary embodiment, the assembly is performed by freezing resulting after freeze-drying in a structure with a controlled direction of ice crystals, as shown in FIG. 4D. An important aspect of 3D printing or print cryo lithography is the cross linking of the printed object. The cross linking of certain products such as alginate by such cross linker agents as CaCl₂ can be done before freezing and in others after freezing. For cross linking after freezing, the frozen object can be immersed in a solution containing the cross linker at a temperature higher than the freezing temperature and the cross linker penetrates the object by diffusion as the frozen object thaws. For example, in FIG. 4D, after freezing has been completed the cooling solution is replaced by a solution at a temperature above freezing temperature containing the cross linker. Than the frozen object thaws from the outer surface in contact with the above freezing temperature fluid and the cross linker penetrates the object by diffusion, to cross link the previously frozen object.

FIG. 5 shows an exemplary surface with the shape outlined by hydrophilic lines. When an aqueous solution is deposited on the exemplary surface of FIG. 5, it may bind only to the hydrophilic surfaces. Similarly, organic molecules such as fat may bind to the hydrophobic outline.

The embodiments of FIGS. 6A-6C show different exemplary methods to produce 2D layers. In FIG. 6A 2D layers are produced using multiple printing heads; in FIG. 6B 2D layers are produced using printing heads with complex shaped nozzles. The assembly may be the same as described in previous examples.

An alternate method to assemble a 3D structure from 2D elements is shown in FIG. 7. In the exemplary embodiment of FIG. 7 the 3D structure that is formed is brought to the separate 2D layers to be deposited. An example application for the method of FIG. 7 is production of a skin alternative.

FIG. 8 shows an exemplary embodiment wherein layers of water, for example, without a gel, can be used as a sacrificial element to generate a cavity in a 3D object made of gels and assembled by freezing.

### Parallel Additive Manufacturing of 3D Objects Made of Aqueous Solutions and Organic Matter

Conventional 3D additive manufacturing methods, such as 3D printing, can produce a complex 3D structure by assembling small volumes of material in a linear fashion, e.g., element by element, first on one layer and then on a subsequent layer using one device. This process limits the speed of manufacturing as one device is occupied by the manufacturing of one object until the end of the 3D object assembly. The major advantage of 3D printing is that it facilitates the manufacturing of a complex 3D object at the macroscopic resolution of the small volume element deposited element by element.

The systems and methods disclosed herein are designed to increase the speed of manufacturing of 3D objects generated by additive manufacturing without affecting the macroscopic resolution. In general, the method comprises producing each 2D layer (or portions thereof) in parallel devices and assembling the resultant 2D layers into the desired 3D structure. Conventional 3D printing has drawn from the principle of printing written matter with 2D digital printers. This principle has resulted in the element by element printing concept. Systems and methods disclosed herein, sometimes referred to “parallel additive manufacturing” or “PMA,” may employ principles of print lithography to form a 3D object that retains a similar resolution as conventional 3D printing. The methods of parallel additive manufacturing generally include forming an object from the deposition of separately prepared 2D layers, thereby increasing the speed of the manufacturing processes. The disclosure further addresses the need to transport each 2D layer to the site where the 3D structure is assembled and bind each 2D layer to the previous layer.

The systems and methods described herein may be particularly relevant to materials made of aqueous solutions and biological matter. In one example, instead of point-by-point printing in three dimensions with 3D printers, multiple single 2D layers can be assembled or printed separately in parallel. The printing may be performed on areas coated with hydrophilic materials to bind water-based compounds. The printing may be performed on areas coated with hydrophobic materials to reject water-based compounds and bind hydrophobic molecules. These methods may generally keep the layers attached to the surface opposing gravity to facilitate transport and the assembly of the 2D layers, regardless of the direction of the surface relative to gravity. The individual layers may be deposited one on top of each other and linked to the previous layers by chemical, optical crosslinking, and/or freezing to generate a 3D structure.

In accordance with certain embodiments, the forces which attach the 2D element to a surface meant to give it mechanical rigidity are less than the forces that bind the same 2D element to the additive manufactured 3D object. Thus, in some embodiments, when the 2D part is brought into contact with the 3D object at the assembly station the force binding the elements to each other is greater than the force binding the element to the surface. Specific applications include, for example, tissue engineering, scaffold manufacturing, and food engineering. In some embodiments, the systems and methods described herein allow the ability to assemble a biological object rapidly. In certain embodiments where freezing is used for assembly, every volume element may be frozen under optimal conditions during the assembly. The optimal conditions can be chosen for either preserving the viability of cells in the structure and/or for generating an optimal microstructure.

Production methods, systems, and devices for 3D additive manufacturing are disclosed herein. The embodiments may overcome certain disadvantages of conventional 3D printing. However, the embodiments may maintain certain advantages of conventional 3D printing. For example, additive manufacturing with 3D printing may enable the assembly of complex 3D objects, wherein each volume element is delivered precisely with good spatial resolution while maintaining good control of local composition. However, a major disadvantage of conventional 3D printing is the linear method in which the object is assembled element by element in a layer, and each layer follows another layer, irrespective of how many printer heads are used.

When employing linear methods, a conventional 3D printing device is generally occupied by the object being assembled until the object is completed. Thus, certain conventional 3D printing methods can produce only one object at the time. The embodiments described herein address this disadvantage of conventional 3D printing and present an approach which may enable resolution of such conventional 3D printing disadvantages by substantially increasing the speed of manufacturing. According to certain embodiments disclosed herein, objects may be assembled with a parallel process in which parts of the 3D object are manufactured separately in parallel having characteristics that can be similar to those achieved by conventional 3D printing. The parts may then be assembled in the final 3D object. The methods are generally referred to herein as Parallel Additive Manufacturing or PAM.

### Principles of Parallel Additive Manufacturing

According to certain methods disclosed herein, the 3D printing process may employ a printing head that moves in a first direction, for example, in an X-Y plane, to produce a 2D layer. The process may employ a printing table that moves in a second direction, for example, in a Z plane relative to the first direction (e.g., X-Y plane) to facilitate the fabrication of a 3D structure. In accordance with other embodiments, the method may comprise completing a first 2D layer deposition and lowering the printing surface. The printing surface may be lowered at least one increment to produce a second 2D layer on top of the first 2D layer. The process may repeat itself one or more times until the 3D object is complete. This method is a linear process that occurs in one device with one or more printer heads.

To speed up the printing process while maintaining the same resolution, in accordance with certain embodiments disclosed herein, the method may involve separating the additive manufacturing device into separate steps, with methods to transport the products of each step to an assembly location. Thus, a system as disclosed herein may comprise one or more, for example, two or more, manufacturing or printing stations and a transport device. According to certain embodiments, the system may comprise:

one or more print stations, each station in which at least one element of the 3D object, for example, a 2D layer, may be printed accurately, the one or more stations optionally operating in a parallel configuration;

a build station in which each successively completed 2D printed layer produced separately may be added to the previous layer to form a 3D object; and

technology to transport the at least one element between the one or more print stations and the build station.

The method as disclosed herein may comprise manufacturing, for example, printing, at least one element of the 3D object, for example, a 2D layer. The method may also comprise assembling the at least one element, optionally adjacent to at least another element of the 3D object. The method may comprise repeating the manufacturing and assembling as necessary, for example, until the 3D object is completed. According to certain embodiments, the method may comprise:

generating, manufacturing, or printing at least one element of a 3D object;

transporting the at least one element of the 3D object; and

assembling the at least one element of the 3D object.

Each element, e.g., 2D layer, can be prepared at a separate station, with several devices working in parallel. The elements, e.g., 2D layers, may then be assembled into a 3D object. There are several ways in which the 3D manufacturing process may be separated into at least two separate steps. In one exemplary method, the assembly surface or build station at which the 2D layers are assembled may move between the different 2D manufacturing stations, where each 2D element may be deposited adjacent to, for example, on top of, a previously deposited 2D element. In another exemplary method, the assembly surface or build station at which the 2D layers are assembled may remain stationary with respect to each 2D element, where each 2D element may be transferred to the assembly surface to form the 3D object.

As disclosed herein, a 3D printing device, which can generate a 3D structure, is separated into at least two independent devices, with a connecting element. The 3D printing device may comprise:

at least one 2D (for example, X and Y axis motion) device that can produce a 2D layer, optionally at least two 2D devices operating in parallel;

a one-dimensional (1D) (for example, Z axis motion) device on which the different single layers may be assembled; and

a device to transport between the 2D layers and the assembled 3D object.

One aspect of the devices disclosed herein is the separation of the additive manufacturing device into at least two components, each one with a separate function. The devices may comprise transport technology to connect between the two devices. For example, in accordance with certain embodiments, the 3D device may comprise multiple 2D printers (for example, with a range of X-Y motion), and at least one 1D printer (for example, with a range of Z motion) that is served by the multiple 2D printers, wherein each 2D printer produces a separate part of the complete object.

There are numerous methods to employ the parallel additive manufacturing technology disclosed herein. The parallel additive manufacturing technology may comprise one or more of the recitations disclosed herein.

The materials used in the technology of this invention may comprise, consist essentially of, or consist of organic molecules and aqueous solution. In some embodiments, the organic matter and/or aqueous solution may be of the type found in organisms and food products. The materials include all the materials commonly used for tissue engineering and all types of food products. One challenge is that objects produced by these materials are usually soft, and particularly when produced as thin 2D layers.

There may be at least two stations used to manufacture the 3D object. One station may be configured to assemble a first part of the structure and a second station configured to assemble the first part of the structure in the final 3D object. Where the first station is used to assemble additional parts of the structure, for example, second, third, fourth parts, and so forth the second station may be configured to assemble each of these into the final 3D object. In some embodiments, one part of the 3D object is prepared separately at one station. This part may be a 2D layer or a portion of a 2D layer. This part can be prepared by a variety of methods, including 2D printing, 2D additive manufacturing, or injection molding.

The disclosed embodiments may be combined with a device to transport the objects between the two stations. The 2D layer or part of the 2D layer may be prepared in such a way that the part can be transported to the site (station) where the 3D element is assembled or vice-versa. For example, the site (station) where the 3D element is assembled may be brought to the site (station) where the part was produced. Ordinarily, these materials made of aqueous solutions and/or organic matter do not have the natural mechanical rigidity to allow their manipulation and transport. In some embodiments, the systems and methods disclosed herein may enable transport of a material made of aqueous solution and/or organic matter. Transport may be enabled under the force of gravity or against the force of gravity, as discussed in more detail below.

In some embodiments, the systems and methods disclosed herein may facilitate the incorporation of an individual component made of aqueous solution and/or organic matter which may have been lacking mechanical rigidity, into a 3D structure at the site of assembly. Thus, the components of parts produced at one station may be designed in such a way that they can be incorporated into the 3D object. Furthermore, the incorporation of the parts produced at separate stations, for example, a 2D layer, can be constructed into the 3D object by any of the methods for binding individual element IVE in a 3D structure disclosed herein, such as chemical cross-linking, thermal binding, laser processing, freezing, any other method disclosed herein, or combinations thereof.

In some embodiments, freezing can be used in the parallel additive manufacturing process to produce a frozen object from parts, such as a 3D object from 2D layers, as disclosed in WO2017/066727.

In general, cross linking is required to provide rigidity to the object. Regardless of the method of cross linking in parallel manufacturing the cross linking can be done before the assembly of the object or after the assembly of the object. In contrast, in conventional 3D printing the cross linking must be made at the latest during the assembly, because the assembly is element by element rather than complete layer by complete layer, and the incorporation of each element in the overall structure is what gives rigidity to the structure.

Transport of Aqueous Material and/or Organic Matter

Conventional production of single layers which are then incorporated into a complete structure is known as laminated object manufacturing. Typically, the individual layers are solid and/or rigid, enabling transfer between production of the single layer and assembly of the final object. Typically, the layers are assembled using a gluing technique. Materials for use in tissue engineering and the food industry, for example aqueous solutions and organic matter, are often not rigid and may lose functionality if not assembled under specific conditions. Generally, aqueous and/or organic materials cannot withstand the force of gravity or be transferred in a way that maintains a two-dimensional structure.

As disclosed herein, materials of aqueous solutions and/or organic matter may be transported from one station to another as a two-dimensional component. For example, materials may be transported from a site of production of an individual element (e.g., a 2D layer) to a site of assembly into a 3D structure. These materials may include those which, under ordinary conditions, typically lack mechanical rigidity. Thus, in some embodiments, the systems and methods disclosed herein may enable the transport of aqueous material and/or organic matter by providing mechanical rigidity to such materials.

In accordance with certain embodiments, mechanical rigidity may be provided to materials of aqueous solutions and/or organic matter by applying surface tension to the material. In some embodiments, a transfer surface can be provided which is designed to bind the individual component materials. For instance, the material can be bound to a rigid surface, e.g., to a hydrophilic and/or hydrophobic surface, as required. Generally, aqueous solutions may bind to a hydrophilic surface. Certain organic molecules, for example, fat molecules, may bind to a hydrophobic surface. In some embodiments, the surface tension of the material to the rigid surface will be enough to overcome the force of gravity, such that the binding of the material to a rigid surface may be performed with gravity or against gravity. The ability to produce and/or transfer the individual component against gravity can provide additional freedom in the design and use of parallel additive manufacturing systems disclosed herein.

In some embodiments, mechanical rigidity may be provided or enhanced by freezing. Individual components of aqueous solutions and/or organic molecules may be cooled or frozen to facilitate transfer from the site of production of the individual component to the site of assembly into the 3D structure. The cooling or freezing can be performed in such a way as to control the microstructure of the individual component.

### Incorporation of Individual Components in a 3D Structure

Materials for use in tissue engineering and the food industry, for example aqueous solutions and organic matter, are often not rigid and may lose functionality if not assembled under specific conditions. As disclosed herein, systems and methods may provide assembly of 2D individual components which would typically lack mechanical rigidity into a 3D structure. The assembly one two or more individual components into a 3D structure may be performed before or after transport between production and assembly into the final structure.

In accordance with certain embodiments, the material may be assembled into a three-dimensional structure in such a way that it can detach from the transport surface and bind to the structure. Methods of solidifying the individual components into a 3D structure such as cross-linking, freezing, thermal binding, laser processing, and combinations thereof can be employed to assemble the 3D structure. The solidification methods generally provide a stronger force of adhesion than the transfer forces which provide mechanical rigidity (e.g., surface tension forces). The solidification can occur as the individual layer is deposited for assembly, facilitating the incorporation of the individual layer into the 3D structure as well as the detachment of the individual layer from the transport surface.

Furthermore, methods may be employed to facilitate detachment of the individual component from the transfer surface during assembly. In some embodiments, changes in pH or temperature, optical, or electrical methods can be employed to release the individual component from the transfer surface. These methods can be employed to provide controlled release of the individual component.

In general, cross linking is required to provide rigidity to the object. Regardless of the method of cross linking in parallel manufacturing the cross linking can be done before the assembly of the object or after the assembly of the object. In contrast, in conventional 3D printing the cross linking must be made at the latest during the assembly, because the assembly is element by element rather than complete layer by complete layer, and the incorporation of each element in the overall structure is what gives rigidity to the structure.

### Multilayer Cryolithography

Multilayer lithography is generally suitable for mass manufacturing of biological material and can substantially decrease the time in which a 3D object made of organic matter is assembled. However, it should be noted that in many situations the organic matter will nevertheless spend a substantial amount of time at room temperature under conditions that may lead to the deterioration of the cells or spoilage of the food product during the manufacturing process. Additionally, when biological 3D objects such as organs and food products are mass produced, they should be suitable for long-term preservation to provide commercial utility. Freezing each element of organic matter while the object is 3D printed may cryopreserve the cells during the assembly process or freeze the food matter in a way that generates the smaller ice crystals, which are generally desirable in frozen foods. Thus, in some embodiments, the biological material can be frozen as it is deposited during parallel additive manufacturing. For instance, the entire deposited layer can be frozen to a previously frozen layer. Furthermore, assembly by freezing may provide stable long-term preservation of the biological matter.

In some embodiments, the systems and methods disclosed herein may bind one or more individual layers into a 3D object by cryolithography. Cryolithography can be used to facilitate parallelization, automation, and significantly increased speed of production. For biological materials in biotechnology and food, cryolithography may also provide substantial advantages aside from increased speed, such as real-time cryopreservation of the biological material as it is manufactured. By using cryolithography, the matter may be frozen with uniform, optimal, and controlled cooling rates for each layer and throughout the entire manufactured structure.

3D cryoprinting and cryolithography may be beneficial in varying applications in the production of complex frozen biological materials. In the cryolithography examples described herein, following deposition of the discrete hydrogel layers, cross-linking and freezing may be employed to assemble the 3D object. In such embodiments, each layer may be produced separately and optionally simultaneously. The layers may be deposited adjacent to each other, for example, on top of each other, to produce the 3D object. The method may further include assembling each layer independently in a coherent structure. The method may include joining the layers in the coherent structure.

An important aspect of 3D cryoprinting or print cryo lithography is the cross linking of the printed object. The cross linking of certain products such as alginate by such cross linker agents as CaCl₂ can be done before freezing and in others after freezing. For cross linking after freezing, the frozen object can be immersed in a solution containing the cross linker at a temperature higher than the freezing temperature and the cross linker penetrates the object by diffusion as the frozen object thaws.

The concepts and the various elements of the invention can be better understood through the following examples.

### EXAMPLES

### Example 1

### Parallel Additive Manufacturing, According to One Embodiment

FIG. 3A-3E are schematic illustrations of the parallel additive manufacturing method and the devices according to one conceptual example. FIGS. 3A-3B illustrate a linear 3D printing process. FIG. 3A illustrates an individual volume element (IVE) used in 3D printing. FIG. 3B shows that a complex 3D object can be made by deposition and merging of a large number of IVE's into the 3D object, for example, according to instructions generated by computer software. The exemplary process of FIGS. 3A and 3B is linear.

FIGS. 3C-3E illustrate a parallel additive manufacturing process. The methods may comprise preparing each 2D layer separately, optionally by using 2D printing, and assembling each 2D layer in a 3D structure, optionally via 1D printing. The steps may include: Preparing a single layer on a 2D printer (in an X-Y axis). There can be many 2D printers performing in parallel. The steps may further include assembling each layer adjacent to another layer by using 1D printing. In some embodiments, each successive layer is assembled on top of a previous layer. In using this approach, many 2D printers can serve a mother 1D print system. The resulting overall printing approach may be faster and more economical. These methods may be particularly applicable to large and complex systems, which may benefit from parallel additive printing.

FIG. 3C shows a single 2D layer generated on a surface. In one embodiment, this layer can be generated using a single head printer, for example, one that has only X-Y degrees of freedom. In another embodiment, this layer can be generated by extrusion from an orifice. A possible material for this layer is an agar gel, an alginate for tissue engineering, a pureed food product, a food product mixed with agar or alginate, or single cells, for example, mixed with an alginate. FIG. 3D shows multiple devices arranged to produce multiple 2D layers in parallel—at the same time, according to one exemplary embodiment. FIG. 3E shows the assembly of the different layers according to one exemplary embodiment.

A variety of methods to assemble the individual structures may be employed. In some embodiments, methods may include bringing each of the individual structures to a central assembly site and binding them together. As shown in FIG. 3, the elements can be assembled as manufactured by the 2D step, as a mirror image (inverted), or any other assembly desired. According to the methods disclosed herein, the assembly of the 2D components in a 3D object may offer another degree of freedom in the assembly.

In accordance with the methods disclosed herein, the individual component may be prepared in such a way that it can be transported to the site where the 3D object is to be assembled. Also, in accordance with the methods disclosed herein, the individual component may be designed in such a way that it can be incorporated into the 3D object. The assembly can use any of the methods for binding individual elements (IVE or voxels) in a 3D structure, such as chemical cross-linking, thermal binding, laser processing, freezing, other methods disclosed herein, and combinations thereof.

### Example 2

### Providing Rigidity to an Individual Component for Transport

In some embodiments, a rigid surface, for example, a hydrophilic rigid surface, can be used for assembly of an individual component. A variety of surfaces can be made hydrophilic. For example, that surface can be a hydrophilic elastomer. Fixate™ is an example of a commercially available hydrophilic elastomer which can be comprised in the surface. The surface may comprise Fixate™, glass, or aluminum. In some embodiments, the surface can be coated, partially coated, or treated to increase hydrophilicity.

In some embodiments, glass can be made hydrophilic by depositing a thin layer of titanium oxide on the glass. Thus, the surface may comprise glass coated with titanium oxide. A glass substrate can additionally or alternatively be made hydrophilic by treating in Piranha solution (acidic or basic), plasma treatment, or ozone cleaning. An aluminum surface can be made to serve as the hydrophilic surface by roughening with fine sand paper and washing with a citric acid solution.

A variety of materials of interest can be deposited on the hydrophilic surface to make the individual components. In an exemplary embodiment, the making of a 2D layer is shown in FIG. 4A. In the exemplary embodiment of FIG. 4A, the layer is deposited on a rigid hydrophilic surface and the direction of deposition is the direction of gravity. As shown in this example, essentially every aqueous solution will bind to the hydrophilic surface, even pure water. The thickness of the layer that will form will generally depend on the amount of materials deposited and the contact angle. In general, the smaller the contact angle the thinner the layer.

Examples of aqueous materials for printing for tissue engineering or in the food industry include:

a) An agar gel

b) An alginate gel, for example, 1% alginate gel. The 1% alginate gel can be prepared by heating up 250 mL of deionized (DI) water until warm. Once warm, the heating is turned off, 2.25 g of table salt and 2.5 g of UltraPure® Agarose are added, and the solution is stirred until clear.

c) A mixture of a pureed food product with either an agar gel or an alginate gel, for example, at a ratio that provides the desired viscosity.

d) Collagen, as described below in another example.

The deposition of these materials on the hydrophobic surface can be completed with a 2D printer or by injection molding.

According to one example, a 3D object may be produced from an agar gel. An agar gel, as disclosed in WO2017/066727 is used to make a 3D object. The steps in this example are shown in FIGS. 4A-4C. As shown in FIGS. 4A-4C:

a) The 2D layer of an agar gel is printed (FIG. 4A). The surface on which the layer of agar is deposited is hydrophilic.

b) The elastomer with the 2D layer is brought to the assembly site (FIG. 4B). The printed aqueous solution binds to the hydrophilic substrate on which the 2D layer is printed. The 2D printed layer can be moved around and turned against the force of gravity. The 2D layer can be manipulated against gravity.

c) The layers are brought to the 3D object assembly device (FIG. 4C). There are various methods to incorporate the 2D layer (for example) in the 3D structure. In general, the forces that bind the individual component to the assembled 3D structure should be larger than the forces that bind the individual component to the hydrophilic surface, to facilitate detachment of the individual component from the transport surface.

d) Some solutions require the use of chemical cross linking. The cross linking of certain products such as alginate by such cross linker agents as CaCl₂ can be done before freezing and in others after freezing. For cross linking after freezing, the frozen object can be immersed in a solution containing the cross linker at a temperature higher than the freezing temperature and the cross linker penetrates the object by diffusion as the frozen object thaws. For example, in FIG. 4D, after freezing has been completed the cooling solution is replaced by a solution at a temperature above freezing temperature containing the cross linker. Than the frozen object thaws from the outer surface in contact with the above freezing temperature fluid and the cross linker penetrates the object by diffusion, to cross link the previously frozen object.

Other physical and/or chemical methods may be employed to remove the individual component from the transfer surface. In an alternative embodiment, mechanical force in the form of, for example, a sharp blade can be utilized to detach the individual component from the transfer surface. It is also possible to detach the individual component from the hydrophilic surface by a number of different methods other than differential binding forces and mechanical forces. For example, it is possible to affect the hydrophilic bonds on the binding surface by changes in pH, temperature, optical, or electrical methods and use external inputs that change the hydrophilic bonds to hydrophobic. This method can be adopted for controlled release of the 2D layer upon deposition for incorporation into the 3D object.

d) The incorporation of the transferred element into the 3D structure occurs in a way similar to the incorporation of a single IVE in a 3D printed structure (FIG. 4C). For example, the incorporation can resemble that described in WO2017/066727, including the mathematical models described therein. Briefly, the layers are deposited in a coolant bath, with a temperature lower than the freezing temperature of the gel. Freezing is used to attach the different layers. The top of the liquid coolant layer is maintained at a predetermined distance Y, from the freezing interface. The freezing interface may propagate in a controlled direction to the liquid coolant top surface, and the freezing velocity may be prescribed by the temperature of the liquid coolant, the predetermined distance Y, and the thermal conductivity of the frozen agar.

In accordance with certain embodiments disclosed herein, a surface of the individual component, for example, the entire surface, for example, the entire 2D layer may be frozen to the adjacent individual component. This embodiment may be implemented instead of freezing each element to the other. Under this embodiment, the incorporation may be performed much faster and the ice crystal structure may form by directional solidification. The unification and can be designed to be uniform, as shown in the freeze-dried sample of FIG. 4D.

The cooling liquid can be liquid nitrogen, subfreezing temperature cooled polyethylene glycol, ethylene glycol, or other subfreezing temperature coolants. The freezing of the layer will attach that layer to the previously frozen layer. This allows the detachment of the 2D gel layer from the hydrophilic elastomer surface because the binding forces between the frozen water molecules is generally stronger than the hydrophilic forces between the gel and the agar. The process can be repeated with another layer. It should be noted that with collagen, the gel solidification temperature is generally higher than the liquid phase temperature. Thus, the same methods can be used, albeit, the immersion liquid is at a higher temperature than that of the liquid deposited 2D layer.

### Example 3

### Hydrophobic Outline on a Hydrophilic Surface, Agar-Based Product

In some embodiments, a single layer to be incorporated into a 3D object by a cryolithography process may be produced on a hydrophobic surface. The hydrophobic surface can be comprised with a portion of a hydrophilic surface. For instance, in some embodiments, the method may comprise drawing an outline of the desired shape with a hydrophobic tool, for example, a lithographic crayon such as Lithographic Crayon No. 3 (William Korn Inc., Manchester, Conn.). The outline may be drawn on a prepared printing surface, for example, an aluminum surface (as shown in FIG. 5).

Lithographic surface treatment to produce complex patterns of hydrophilic and hydrophobic surfaces can also be used to produce a complex shape. When an aqueous solution is deposited on the mixed surface it is expected it will bind to the hydrophilic surfaces. An organic molecule, such as fat, is expected to bind to the hydrophobic outline. Therefore, by depositing an aqueous solution on the surface, for example, with a roller, a 2D layer can be attached to the 3D structure as described previously.

In an exemplary embodiment with agar, a 2D layer may be deposited on the hydrophilic assembly surface at a temperature at which the agar is liquid. When the layer has begun to gel, the transfer surface can be transported to the assembly site. The transfer surface may be kept at a higher temperature than the assembly surface. The 2D layer may then be deposited on the site where the 3D structure is to be assembled. Once the agar begins to gel and bind to the 3D structure, the layer can be removed from the surface, for example, by peeling. The process can be continued for multiple layers with the 2D layer in a liquid form incorporated onto a gelled 3D object at room temperature.

### Example 4

### Hydrophobic Outline on a Hydrophilic Surface, Collagen-Based Product

Collagen can be used to prepare matrices on which cells can grow into 2D and 3D configurations. A collagen-based product may be produced by the method described in Example 3. However, in the treatment of collagen, the liquid form is at a low temperature and the gel form is at an elevated temperature. Generally, collagen solutions are fluid at low temperatures, for example, close to 0° C. and polymerize (solidify) as the temperature is elevated.

In some embodiments, the methods may comprise cross-linking native collagen. In a prophetic example, collagen can be dissolved in 0.005 M acetic acid at a concentration of 1 mg/mL at a temperature of 5° C. Equal volumes of collagen solution and buffer can be mixed in an ice bath at a pH of 7.3 to 7.4. Cross-linking can be performed by increasing the temperature from the ice bath temperature to a temperature above 20° C., in some embodiments to a temperature above 30° C. An amount of cross-linking can be controlled as a direct function of the elevated temperature and the extended time. It is expected after cross-linking has occurred a subsequent reduction in temperature, for example, back to 4° C. will not break the links formed.

While not wishing to be bound by any particular theory, it is believed the collagen solution is fluid at 4° C. Upon elevation of temperature, for example, to 26° C., it is believed an apparent nucleation event occurs. The growth of cross-linked gel structures (filaments) is believed to be a time dependent process.

Various compositions that mimic a natural extracellular matrix may be used for producing artificial tissues, as described herein. In some embodiments, the solution can be or comprise Matrigel® Matrix (Corning Incorporated, Corning, N.Y.). Matrigel is generally liquid at a temperature of about 0° C. and forms a gel at a temperature of about 37° C. Accordingly, individual components may be formed from a collagen solution, for example, Matrigel® Matrix.

### Example 5

### Preparation of Individual Layers of Aqueous Material and/or Organic Matter

A single layer of an aqueous material product or an organic material product may be produced according to methods disclosed herein. The single layer may be produced by injection of a composite shape onto a 2D layer. As shown in FIG. 6A, a single layer may be produced by one or more printer-heads. As shown in FIG. 6B, a single layer may be generated by injection heads in which the distribution nozzle has a specifically selected head. In some embodiments, a single layer may be formed by extrusion and deposited as a 2D layer at the site of assembly of the 3D object. As shown in FIG. 6C, a single layer may be produced by freezing or gelation. For example, in the exemplary embodiment of FIG. 6C, an immersion liquid is maintained at a first temperature. Where the aqueous solution comprises agar, the immersion liquid can be maintained at a low temperature, as described above. Where the aqueous solution comprises collagen, the immersion liquid can be maintained at a high temperature, as described above. Furthermore, the immersion liquid can also contain nutritional elements, for example, for preserving composition, such as intracellular composition for collagen extracellular matrices or for cells in agar or alginate.

### Example 6

### Transport of 2D Layers and 3D Assembly of 2D Layers

As shown in FIG. 7, to different methods may be employed for producing the 2D layer for parallel additive manufacturing. As mentioned earlier, it is possible to generate a 3D object by bringing the 2D layer to the assembly site or by bringing the 3D layer to the site at which a 2D layer is formed. As shown in FIG. 7, the location at which the 3D structure is assembled may be brought to different sites at which various 2D layers are added. In the prophetic example, a first 2D layer is transported with a conveyor to the site of the manufacturing of the second 2D layer. The second 2D layer is incorporated with the first 2D layer onto a 3D structure as the first 2D layer passes the site of the production of the second 2D layer. The process can continue with subsequent layers as desired.

The process can be performed in a controlled temperature fluid, as shown in FIG. 4C. The 2D layer can be deposited with any of the methods described in the previous examples, including multi-shape nozzles or the deposition of a complex 2D layer as in Example 3. The manufacturing of a skin replacement is used as an example. In general, for all techniques, it is possible to bring the partial element to the site of assembly of the 3D object. It is also possible to bring the 3-D assembly site to the location of the production of the part element.

### Example 7

### Gelation of an Alginate-Based Product

Biological 3D objects may be formed from sodium alginate. As a prophetic example, a solution of 3% w/v sodium alginate can be mixed with 75 mM calcium carbonate (CaCO₃) and 150 mM D-Gluconic acid δ-lactone (GDL). The sodium alginate solution can be prepared by mixing 6 g sodium alginate (Spectrum Chemical Mfg. Corp., Gardena, Calif.) in 200 mL of deionized (DI) water and stirring until the solution is homogenous. A solution of 75 mM CaCO3 and 150 mM GDL can be prepared by mixing 0.075 g of 98% pure CaCO₃ powder (Acros Organics, N.J.) and 0.294 g of GDL (Sigma-Aldrich Co., St Louis, Mo.) in 10 mL of DI water. The water can be added to the CaCO₃ and GDL powders immediately before use.

Before printing, water can be added to the CaCO₃ and GDL powders and then one part of the solution is mixed with two parts 3% w/v sodium alginate solution until homogenous. The 2:1 ratio of alginate to CaCO₃-GDL results in a 2% w/v sodium alginate, 25 mM CaCO₃, and 50 mM GDL solution. This concentration of sodium alginate, CaCO₃, and GDL provides a suitable viscosity before cross-linking, allowing for a suitable cross-linking speed and structural rigidity after printing. Generally, the amount of the cross-linking agents must be metered in such a way that the material on the layer formation surface is sufficiently gelled to facilitate attachment when inverted, but sufficiently fluid to facilitate cross-linking to the layers on the assembly surface.

### Example 8

### Preparation of a Food Material

A food material may be produced by the methods and systems described herein. In a prophetic example, food material can be mixed with 1% w/v sodium alginate (Spectrum Chemical Mfg. Corp., Gardena, Calif.). Upon deposition on the printing surface, the solution can be cross-linked with Calcium Chloride (CaCl₂). Generally, any kind of food product can be used. For example, pureed beef or liver, mashed potatoes, or cells grown for artificial tissues. Sodium alginate and CaCl₂ are substances approved by the FDA as additives for food.

Freeze-dried potato flakes can be mixed with water according to the manufacturer's instructions, to make a potato puree. The puree can be mixed with 1% w/v solution of sodium alginate in water at a ratio of 3:1 puree to sodium alginate solution. Similarly, a meat puree, optionally an artificially produced meat puree, can be mixed in a 3:1 volume ratio with 1% w/v sodium alginate solution (prepared as previously described) until homogenous. The solution is crosslinked with CaCl₂, as previously described. It is expected that all types of food products can be incorporated into such products and produced by such methods. The product can be formed by any of the methods for producing individual 2D layers described herein. Note that mirror images will form when generating a shape such as that shown in FIG. 6.

In some embodiments, the methods disclosed herein can be used to produce food for patients with dysphagia. Dysphagia may affect elderly patients and/or patients who have suffered a stroke. In general, patients who suffer from dysphagia cannot chew and swallow their food. Their meals generally include mashed foods with typically unappetizing appearance. 3D printing can be used to produce food products with a consistency which is suitable for patients with dysphagia, optionally with a more appetizing appearances.

However, conventional 3D printing is typically a slow process and cannot supply the needs of the large population suffering from dysphagia. Furthermore, the food generally must be preserved in a frozen state for effective manufacturing and distribution. The cryolithography technique detailed herein can both manufacture these types of foods in industrial quantities and freeze the foods with optimal cooling rates for the highest quality.

### Example 9

### Shaping 3D Objects by Sacrificial Elements

The technology disclosed herein can be also used to obtain complex shapes using sacrificial elements. In water-based materials, such as gel scaffolds for tissue engineering, the sacrificial element can be pure water (for objects that undergo freeze-drying) or a high osmolality aqueous solution for food. FIG. 8 shows a 3D object made of multiple layers of different materials. When the device is assembled by freezing, the center layers shown in white can be pure water, while the other layers show in shaded colors can be gels of different compositions. Upon thawing or freeze-drying the water will either sublimate or drain away, leaving behind a void in the desired shape.

### Example 10

### Freezing Individual Layers to Improve Rigidity for Transport

In some embodiments, the individual 2D layer is sufficiently rigid for transportation. In some embodiments, rigidity of the individual layer may be improved by cooling or freezing. The frozen individual layer can be transported by mechanical devices to the assembly site of the 3D object. The frozen individual layer can be thawed in place and bound to the structure by cross-linking.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure, and are intended to be within the scope of the invention. Accordingly, the foregoing description and drawings are by way of example only.

1. A method of additive manufacturing biological matter comprising:
preparing an aqueous solution comprising organic matter;
combining the aqueous solution with a thickening agent to produce a deposition mixture;
forming the deposition mixture into a plurality of two-dimensional individual volume elements in parallel, each individual volume element formed on a first surface;
transferring the plurality of individual volume elements to a second surface;
assembling the plurality of individual volume elements on the second surface in a three-dimensional array; and
solidifying the plurality of individual volume elements in the three-dimensional array, thereby additive manufacturing the biological matter.

2. The method of claim 1, wherein forming the deposition mixture into a plurality of two-dimensional individual volume elements comprises increasing mechanical rigidity of the deposition mixture to form the plurality of two-dimensional individual volume elements.

3. The method of claim 2, wherein forming each individual volume element on a first surface comprises binding each individual volume element to the first surface to provide the mechanical rigidity to the plurality of two-dimensional individual volume elements.

4. The method of claim 3, further comprising:
releasing the plurality of individual volume elements from the first surface, wherein binding each individual volume element to the first surface is performed against the force of gravity,
wherein additive manufacturing the biological matter comprises additive manufacturing an organ, a tissue, or tissue scaffold, and
comprising implanting the organ, tissue, or tissue scaffold in a subject in need thereof.

5.-7. (canceled)

8. The method of claim 4, further comprising evaluating the organ, tissue, or tissue scaffold in vitro.

9. The method of claim 4, further comprising evaluating the organ, tissue, or tissue scaffold in vivo.

10. The method of claim 1, wherein the thickening agent comprises at least one of agar, collagen, and an alginate, and the method further comprises:
cross-linking the plurality of individual volume elements in the three-dimensional array.

11.-17 (canceled)

18. A method of additive manufacturing a food product comprising:
preparing an aqueous solution comprising a food base;
combining the aqueous solution with a thickening agent to produce a deposition mixture;
forming the deposition mixture into a plurality of two-dimensional individual volume elements in parallel, each individual volume element formed on a first surface;
transferring the plurality of individual volume elements to a second surface;
assembling the plurality of individual volume elements on the second surface in a three-dimensional array; and
cross-linking the plurality of individual volume elements in the three-dimensional array, thereby additive manufacturing the food product.

19. The method of claim 18, further comprising:
selecting the viscosity and texture of the food product to be suitable for a subject with esophageal dysphagia:

20. (canceled)

21. The method of claim 18, wherein the food base is selected from the group consisting of a protein, a fat, a carbohydrate, and cells grown in an in vitro cell culture,
wherein the edible thickening agent comprises sodium alginate, and
wherein cross-linking the plurality of individual volume elements comprises combining the plurality of individual volume elements with calcium chloride.

22.-24 (canceled)

25. The method of claim 18, wherein cross-linking the plurality of individual volume elements involves freezing or heat-treating the plurality of individual volume elements.

26. The method of claim 18, further comprising:
structurally reinforcing the plurality of individual volume elements before transferring the plurality of individual volume elements to the second surface, and
wherein structurally reinforcing the plurality of individual volume elements comprises freezing the plurality of individual volume elements.

27. (canceled)

28. A method of additive manufacturing a three-dimensional structure comprising an aqueous solution or organic matter, the method comprising:
preparing a first solution comprising the aqueous solution or organic matter;
forming the first solution into a plurality of two-dimensional individual volume elements in parallel, each individual volume element formed on a first surface;
transferring the plurality of individual volume elements to a second surface;
assembling the plurality of individual volume elements on the second surface in a three-dimensional array; and
freezing the plurality of individual volume elements in the three-dimensional array, thereby additive manufacturing the three-dimensional structure.

29. The method of claim 28, further comprising freezing the plurality of individual volume elements on the first surface.

30. A system for additively depositing elements comprising an aqueous solution or organic matter, the system comprising:
one or more print stations operating in a parallel configuration, each print station comprising an individual volume element print head positioned to deposit the individual volume element on a first surface and a print station temperature control device;
a build station configured to arrange the individual volume element in a three-dimensional structure on a second surface, the build station comprising a build station temperature control device; and
a transport subsystem configured to transport the individual volume element between the first surface and the second surface, the transport subsystem comprising a transport temperature control device.

31. The system of claim 30, wherein the first surface comprises a hydrophilic portion arranged in a desired design for a two-dimensional individual volume element.

32. The system of claim 31, wherein the first surface further comprises a hydrophobic portion.

33. (canceled)

34. The system of claim 30, wherein the print station temperature control device is configured to maintain a liquid temperature of the individual volume element.

35. The system of claim 30, wherein the build station temperature control device is configured to maintain a solid temperature of the three-dimensional structure.

36. The system of claim 30, wherein the transport subsystem temperature control device is configured to maintain a solid temperature of the individual volume element.

37. The system of claim 30, wherein the transport subsystem comprises a binding mechanism configured to bind the individual volume element to the first surface during transport; and
wherein the transport subsystem comprises a removal mechanism configured to remove the individual volume element from the first surface for assembly.

38. (canceled)

39. The system of claim 30, wherein the individual volume element print head is positioned to deposit the individual volume element on the first surface against the force of gravity.
